(19) United States
(12) Patent Application Publication
(10) Pub. No.: US 2009/0198497 A1
(43) Pub. Date: Aug. 6, 2009

(54) METHOD AND APPARATUS FOR SPEECH SYNTHESIS OF TEXT MESSAGE

(75) Inventor: Nyeong-kyu Kwon, Daejeon (KR)

Correspondence Address: MCNEELY BODENDORF LLP, P.O. BOX 34175, WASHINGTON, DC, 20043, US

(73) Assignee: Samsung Electronics Co., Ltd., Suwon-si (KR)

(21) Appl. No.: 12/343,585

(22) Filed: Dec. 24, 2008

(30) Foreign Application Priority Data
Feb. 4, 2008 (KR) 2008-11229

(51) Int. Cl. G10L 13/08

(52) U.S. Cl. 704/260; 704/E13.002

(57) ABSTRACT

Provided is a method and apparatus for speech synthesis of a text message. The method includes receiving input of voice parameters for a text message, storing each of the text message and the input voice parameters in a data packet, and transmitting the data packet to a receiving terminal.

### CROSS-REFERENCE TO RELATED APPLICATION

This application claims the benefit of Korean Patent Application No. 2008-11229, filed Feb. 4, 2008 in the Korean Intellectual Property Office, the disclosure of which is incorporated herein by reference.

### BACKGROUND OF THE INVENTION

1. Field of the Invention

Apparatuses and methods consistent with aspects of the present invention relate to speech synthesis of a text message, and more particularly, to speech synthesis of a text message, in which a voice message service utilizing speech synthesis is added to an existing text message service such that one of a text message and a voice message that has been converted through speech synthesis may be selectively used, depending on the circumstances of a user of a receiving terminal (hereinafter referred to as “receiver”).

2. Description of the Related Art

Services provided through mobile terminals include those that allow messages to be sent and received, in addition to services that allow for typical voice calls. The two main types of messages are text messages and voice messages. Text messaging is experiencing increasing widespread use due to its low cost and convenience. This trend is particularly prevalent among young users.

The most common method of using a text message service is that in which a sender creates a desired text message through a mobile terminal, and then transmits the text message to be received by a receiving terminal. The most common method of using a voice message service is that in which a user records a desired voice message on an ARS server through a sending terminal for storage in a personal voice mailbox. The ARS server then transmits the message in the personal voice mailbox to a receiving terminal.

In addition, text-to-speech conversion message services are available which convert a text message into a voice message using speech synthesis technology before transmission of the converted message. With such services, a text message generated by a sender is converted in a speech synthesis network server utilizing speech synthesis technology, after which the converted message is transmitted to a terminal of a receiver.

Among such conventional message services, in the case of voice message services, the sender must perform the inconvenient task of recording his or her voice message through a sending terminal, while the receiver must perform the inconvenient task of connecting to his or her own voice mailbox to retrieve to the voice message.

With respect to services in which a text message is converted into a voice message utilizing speech synthesis technology, it is difficult to provide the text message with voice attributes (e.g., voice gender, pitch, volume, speed, and expression of emotions) that are desired by the sender when the text message is converted into a voice message. Moreover, there are instances when either a text message or a voice message is not desirable due to the present circumstances of the receiver. For example, if the receiver is driving, visually impaired or too young to be able to read, a voice message service is preferable to a text message service. On the other hand, if the receiver is in a meeting or otherwise at a location requiring silence such as a library, a text message service is preferred to a voice message service.

Accordingly, there is a need for a technology which does not require a user to record a message and instead, requires only that the user create a text message at a sending terminal and then transmit the same, after which the receiver at the receiving terminal is able to selectively receive, depending on the circumstances of the receiver, either the text message or a voice message converted using speech synthesis.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. Accordingly, aspects of the present invention provide a method and apparatus for speech synthesis of a text message, in which a text message created by a sender is converted into a voice message that closely reflects the emotional state of the sender before transmission to a receiver.

Aspects of the present invention also provide a method and apparatus for speech synthesis of a text message, in which a message may be selectively received as a text message or a voice message, depending on the circumstances of a receiver.

According to an aspect of the present invention, there is provided a method for speech synthesis of a text message, the method including: receiving input of voice parameters for a text message; storing each of the text message and the input voice parameters in a data packet; and transmitting the data packet to a receiving terminal.

According to another aspect of the present invention, there is provided a method for speech synthesis of a text message, the method including: extracting voice information and voice parameters for a text message from a data packet that includes the text message and the voice parameters for the text message; synthesizing speech using the extracted voice information and the voice parameters to obtain a voice message; and outputting at least one of the text message and the voice message, depending on the circumstances of a user.

According to another aspect of the present invention, there is provided an apparatus for speech synthesis of a text message, the apparatus including: a voice parameter processor which receives input of voice parameters for a text message; a packet combining unit which stores each of the text message and the input voice parameters in a data packet; and a transmitter which transmits the data packet to a receiving terminal.

According to another aspect of the present invention, there is provided an apparatus for speech synthesis of a text message, the apparatus including: a voice information extractor which extracts voice information and voice parameters for a text message from a data packet that includes the text message and the voice parameters for the text message; a speech synthesizer which performs speech synthesis using the extracted voice information and the voice parameters to obtain a voice message; and a service type setting unit which outputs at least one of the text message and the voice message, depending on the circumstances of a user.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus for speech synthesis of a text message according to an embodiment of the present invention;

FIGS. 2A and 2B are schematic diagrams of partial structures of data packets according to embodiments of the present invention;

FIG. 3 is a block diagram of an apparatus for speech synthesis of a text message according to another embodiment of the present invention;

FIG. 4 is a flowchart of a method for speech synthesis of a text message according to an embodiment of the present invention; and

FIG. 5 is a flowchart of a method for speech synthesis of a text message according to another embodiment of the present invention.

### DETAILED DESCRIPTION OF THE EMBODIMENTS

The various aspects and features of the present invention and methods of accomplishing the same may be understood more readily by reference to the following detailed description of exemplary preferred embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention is defined by the appended claims. Like reference numerals refer to like elements throughout the specification.

A method and apparatus for speech synthesis of a text message according to an embodiment of the present invention are described hereinafter with reference to the block diagrams and flowchart illustrations. It will be understood that each block of the flowchart illustrations, and combinations of blocks in the flowchart illustrations, can be implemented by computer program instructions. These computer program instructions can be provided to one or more processors of a general-purpose computer, special purpose computer, portable consumer devices such as mobile phones portable media players, and/or other programmable data processing apparatus to produce a machine, such that the instructions, which execute via the processor of the computer or other programmable data processing apparatus, create mechanisms for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction mechanisms that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide the mechanisms for implementing the functions specified in the flowchart block or blocks.

Further, each block of the flowchart illustrations may represent a module, segment, or portion of code, which comprises one or more executable instructions for implementing the specified logical function(s).

It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

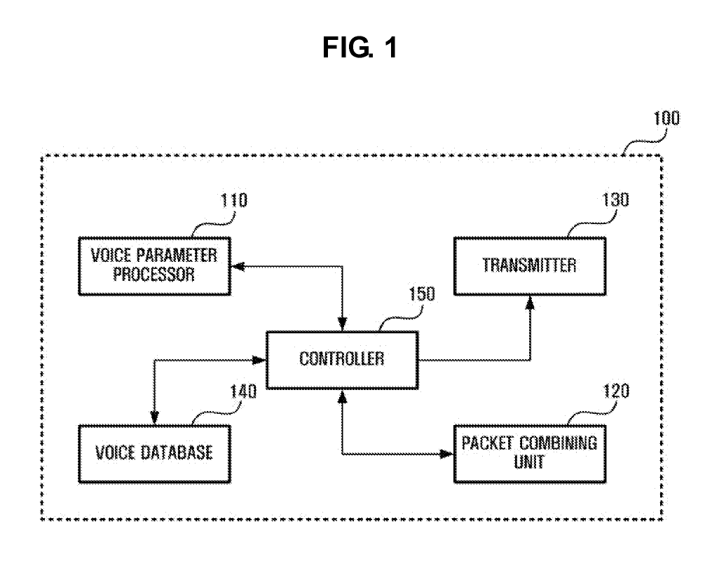

FIG. 1 is a block diagram of an apparatus 100 for speech synthesis of a text message according to an embodiment of the present invention. The apparatus 100 includes a voice parameter processor 110, a packet combining unit 120, a transmitter 130, a voice database 140, and a controller 150 which controls each of the voice parameter processor 110, the packet combining unit 120, the transmitter 130, and the voice database 140. The voice parameter processor 110 receives input of voice parameters for a text message. The packet combining unit 120 stores each of a text message and the input voice parameters in a data packet. The transmitter 130 transmits the data packet to a receiving terminal. The voice database 140 includes voice parameters. It is understood that additional units can be included in addition to or instead of the shown units. For instance, a display and/or keypad can be used where the apparatus 100 is included in a mobile phone, portable media device, and/or computer in aspects of the invention, and the database 140 need not be used or incorporated within the body of the apparatus 100 in all aspects. Further, while shown as separate, it is understood that ones of the units can be combined while maintaining equivalent functionality.

A “text message” in the apparatus 100 of FIG. 1 may refer to a text message that is presently input by a user, or a text message that was previously created by the user and stored in an internal storage space (not shown). Such text message can be sent using a short message service (SMS) protocol or an instant message protocol, but is not specifically so limited.

As described above, the voice parameter processor 110 of the apparatus 100 of FIG. 1 receives input of voice parameters for a text message. “Voice parameters” refer to intervening variables for speech synthesis, and are used to convert a text message into a voice message through speech synthesis such that the voice message closely resembles the actual voice of the sender and conveys the emotions of the sender. Voice parameters may include at least one of a specific tone quality of the sender, pitch, volume, speed, expression of emotions, voice gender or combinations thereof. Such voice parameters can be preexisting, downloaded, and/or transferred from removable storage such as an SD card. Further, it is understood that other voice parameters can be used in addition to or instead of these exemplary parameters to the extent that the voice parameters enable voice synthesis at the receiving terminal of the text sent from the apparatus 100. Lastly, where fewer than all of the voice parameters are stored in the voice database 140, such non-stored voice parameters can be set through user interaction with the apparatus 100 and/or through default settings.

“Specific tone quality of the sender” refers to the particular characteristics and sound of the voice of the sender. The receiver is able to identify the sender from his or her specific tone quality. To allow for the utilization of this voice parameter, the voice database 140 preferably includes data of the specific tone quality of the sender (hereinafter referred to simply as “specific tone quality of the sender”). However, it is understood that the specific tone quality of the sender need not be so stored, such as when stored at a receiving terminal. Further, it is understood that the specific tone quality is not limited to the specific sender, such as when the specific tone quality is of another person who the sender is wishing to imitate while the text message is synthesized at the receiving terminal.

Voice pitch may be one of a high-pitched tone, a medium-pitched tone, and a low-pitched tone, but is not so limited.

Voice volume may be expressed as a particular degree of loudness.

Voice speed may be one of fast, normal, and slow.

Expression of emotions may be one of happiness, anger, sadness, and joy, but is not so limited.

Further, voice gender may be one of a male voice and a female voice, but could be otherwise created (such as a robotic voice).

Through the specific tone quality of the sender and the voice parameters, the sender is able to convey his or her emotions using a voice that closely resembles his or her real voice. Alternatively, the voice using a voice that is different from his or her real voice through selection of voice gender and voice parameters. Examples could also be to use celebrity voices or well known voices, or merely modification on the sender's actual voice through changes in speed, pitch and gender.

The selection of the voice parameters may be performed through an input mechanism, such as a keypad or a touchscreen, included in the terminal housing the apparatus 100. By way of example, voice pitch, voice volume, and voice speed may be selected according to level (high, medium, low), or may be selected as a numerical value. For example, voice volume may be adjusted by selecting high, medium, or low, or may be adjusted by selecting a number from 1 to 10, where 1 is the lowest and 10 is the highest. However, the selection can be according to other relative terms, such as high versus low or fast versus slow.

Additionally, the voice parameter processor 110 may combine the input voice parameters for storage as a single unit of information which can be used at a later time. These stored units can be included in a memory housing the database 140, can be within the database 140, or can be stored separately. However, it is understood that fewer than all parameters can be stored together, with remaining parameters being separately provided in the terminal or presumed between the sending and receiving terminals. Such storage can be in an internal and/or removable storage of the apparatus 100, or can be connected to the unit 100 over a network.

To provide an example, it is assumed that the sender is female and the sender is frustrated at having to wait for a friend who is late for an appointment. It is further assumed that the sender transmits a text message and a voice message generated through speech synthesis under such circumstances, such as “Where are you?! Why are you so late?” The sender further selects voice parameters as follows: a specific tone quality of the sender, a “high” pitch, a “10” volume (on a scale from 1 to 10 with 10 being the highest), a “normal” speed, and an “angry” expression of emotion. Hence, a text message with these voice parameters to the receiving terminal that conveys, when the text message is speech synthesized using the transmitted parameters, the actual emotions of the sender.

In this above, the sender may select a specific tone quality of the sender such that emotions are conveyed using a voice that closely resembles the sender's real voice, or alternatively, may select a specific tone quality of the sender so that the voice message is realized using a voice that is different from the sender's real voice. To further enhance this effect, voice gender may also be selected using the opposite gender (a male voice gender in this example where the sender is female).

Subsequently, the sender stores the voice parameters as information in a predetermined format such that if the same or similar situation is encountered in the future, a voice message that conveys the emotions of the sender may be transmitted to the receiver without having to select each of the voice parameters. As such, the combination could be stored using descriptive filed names, such as anger, happy, excited, which can be selected according to type of message being sent. Moreover, default combination scan be used or can be assigned according to corresponding receiving terminals and phone numbers.

In this case, the predetermined format in which the voice parameters are stored may be that of a “file” format. When such a file is stored, it is preferable that a name be used for the file that allows for the contents of the file to be easily ascertained. However, the types of the voice parameters, the manner in which the voice parameters are indicated, and the different storage formats for the voice parameters may be varied in a multitude of ways as may be contemplated by those skilled in the art, and these aspects of the voice parameters are not limited to the disclosed embodiments of the present invention.

The packet combining unit 120 stores each of the text message and the voice parameters input in the voice parameter processor 110 in a data packet. It is noted that if the sending terminal and the receiving terminal each include at least a portion of a common voice database (for instance a synchronized database 140 or where the receiving terminal stores previously received voice parameters in another database), the voice parameter processor 110 may extract indexes of the voice database 140 corresponding to the input voice parameters, and store the indexes as information of a predetermined format, such that the sender is able to use the indexes in the future. Accordingly, in this case, the packet combining unit 120 stores in the data packet the indexes of the voice database 140 extracted by the voice parameter processor 120, instead of the voice parameters. As such, the size of the message can be reduced during transmission since only the index is sent as opposed to all of the parameters referenced in the index.

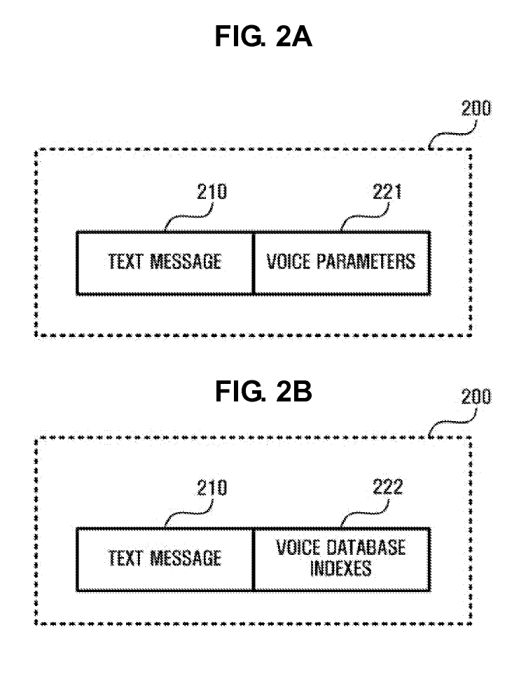

FIGS. 2A and FIG. 2B are schematic diagrams of partial structures of data packets 200 according to an embodiment of the present invention. FIG. 2A shows a data packet 200 according to an embodiment of the present invention which includes a text message 210 created by a sender and voice parameters 221 which are intervening variables for speech synthesis. FIG. 2B shows an embodiment in which, as mentioned above when describing the function of the voice parameter processor 110, indexes 222 of a voice database are included in the data packet 200 in place of the voice parameters 221. Hence, the text message created by the sender and the voice parameters selected by the sender (or indexes of the voice database) are included in the data packet 200 and transmitted to the receiving terminal such that additional voice data selection for speech synthesis will not be required at the receiving terminal.

The transmitter 130 transmits the data packet including the text message and the voice parameters (or indexes of the voice database) to the receiving terminal. Since the data packet transmitted by the transmitter 130 is transmitted to the receiving terminal through a conventional mobile communications system, such as a base station, an exchanger, a home location register, message service center, etc., a detailed description of such transmission will not be provided herein.

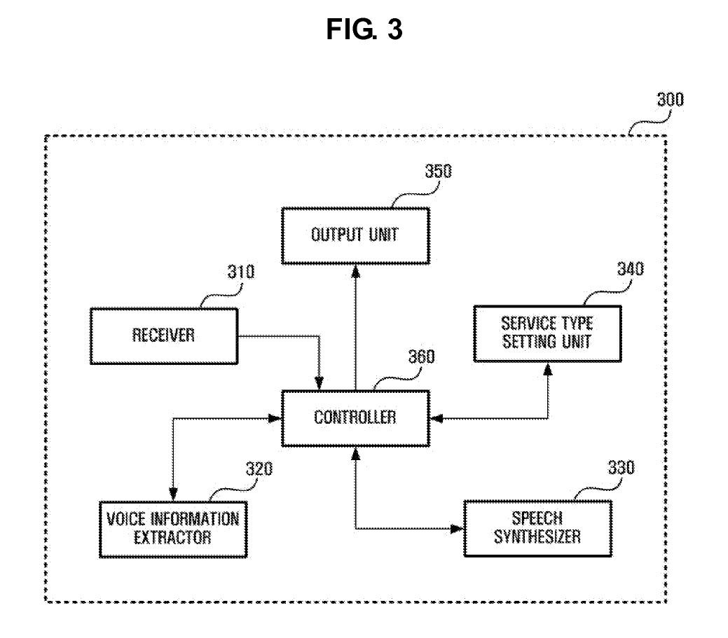

FIG. 3 is a block diagram of an apparatus 300 for speech synthesis of a text message according to another embodiment of the present invention. The apparatus 300 includes a receiver 310, a voice information extractor 320, a speech synthesizer 330, a service type establishing unit 340, an output unit 350, and a controller 360. The receiver 310 receives a data packet that includes a text message and voice parameters for the text message. The voice information extractor 320 extracts voice information and voice parameters for the text message from the data packet received by the receiver 310. The speech synthesizer 330 synthesizes speech using the voice information and voice parameters extracted by the voice information extractor 320. The service type setting unit 340 establishes whether to output a text message or a voice message created through speech synthesis (or both), depending on the particular circumstances of the user. The output unit 350 outputs the message service as set by the service type establishing unit 340. The controller 360 controls each of the receiver 310, the voice information extractor 320, the speech synthesizer 330, the service type establishing unit 340, and the output unit 350. It is understood that additional units can be included in addition to or instead of the shown units. For instance, a display and/or keypad can be used where the apparatus 300 is included in a mobile phone, portable media device, and/or computer in aspects of the invention. Further, while shown as separate, it is understood that ones of the units can be combined while maintaining equivalent functionality. Lastly, it is understood that the apparatus 100 and 300 can be included in a single device, such as a mobile phone, portable media device, and/or computer, with duplicative units combined to allow both transmission and reception of text messages with voice parameters.

Reference will be made also to the apparatus 100 of FIG. 1 for the following description. In the above description of the apparatus of FIG. 1, it was stated that one of voice parameters and indexes of a voice database corresponding to the voice parameters may be included in a data packet. For the following description, it will be assumed for purposes of illustration that voice parameters are included in the data packet. Accordingly, in describing the apparatus 300 of FIG. 3 below, any mention of “voice parameters” may also be taken to encompass “voice database indexes” in the case where the sending terminal and the receiving terminal exist in the same voice database.

The receiver 310 of the apparatus 300 of FIG. 3 receives a data packet (i.e., a data packet including a text message and voice parameters) that is transmitted, such as by the transmitter 130 of the apparatus 100 of FIG. 1. The voice information extractor 320 separates the text message and the voice parameters in the data packet received by the receiver 310, and then extracts voice information for the text message. “Voice information” includes at least one of syntax structure and cadence information.

In greater detail, for purposes of speech synthesis, the voice information extractor 320 determines the syntax structure (hereinafter referred to as “syntax analysis) of the text message so that cadence information naturally present in a voice (such as intonation, emphasis, sustain time, etc.) is reflected in the synthesized speech so as to sound as if an actual person is talking. This may include what is referred to below as “pre-processing” in which information in the text not written in a particular target language, such as numbers, symbols, and foreign words, is first converted into actual words in the target language.

For this purpose, the voice information extractor 320 classifies the parts of speech in the separated text message (hereinafter referred to as “morpheme analysis”). After classifying the parts of speech, the voice information extractor 320 performs syntax analysis to produce a cadence effect of the synthesized speech.

Syntax analysis involves generating grammatical relation information between syllables using morpheme analysis results and predetermined grammar rules. This information is used to control cadence information of intonation, emphasis, sustain time, etc.

After syntax analysis, the voice information extractor 320 converts sentences of the text message into sound using pre-processing, morpheme analysis, and syntax analysis results. Subsequently, the speech synthesizer 330 synthesizes speech using the voice information extracted by the voice information extractor 320 and the voice parameters. As such, received in the data packet separate voice data selection for speech synthesis does not need to be performed at the receiving terminal.

The service type setting unit 340 establishes whether to output the text message or the voice message generated through speech synthesis by the speech synthesizer 330 (hereinafter referred to simply as “voice message”). In either case, the determination is made on the basis of the particular circumstances of the user. However it is understood that the service type setting unit 340 need not be used in all aspects, such as when the device always outputs speech. Such setup can be accomplished through a keypad and/or touch screen, but is not limited thereto.

For example, if the user is driving or is too young to be able to read, set up is performed so that output of the voice message is performed when receiving the text message and voice message. Alternatively, if the user is in a meeting or is otherwise in a situation where receiving a voice message is not desired, set up is performed so that output of the text message is performed. Hence, message output is optimized, depending on the particular circumstances of the user.

Of course, set up may be performed so that output of both the text message and the voice message is performed.

The output unit 350 outputs the message as set by the service type setting unit 340. That is, the text message is output on a screen (not shown) of the receiving terminal, while the voice message is output through a speaker (not shown) of the receiving terminal. Hence, the output unit 350 of the present invention may include both the screen (not shown) and speaker (not shown) of the receiving terminal, or may be connected to a screen and/or speaker using a wired and/or wireless connection as in a hands free driving environment.

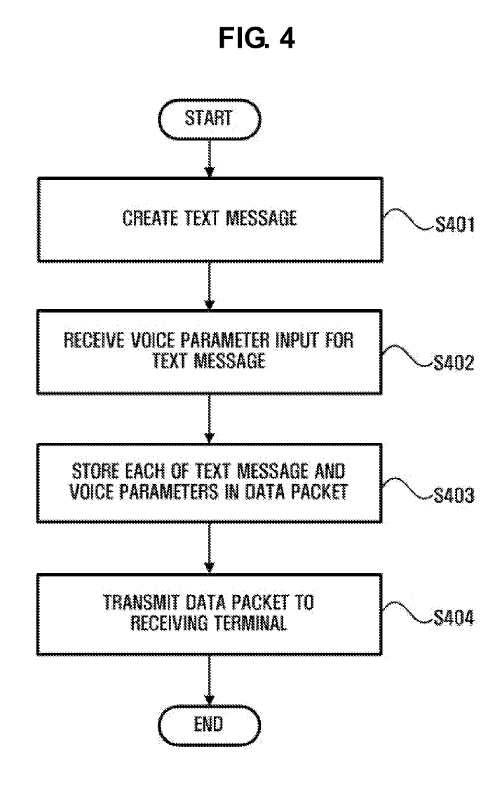

FIG. 4 is a flowchart of a method for speech synthesis of a text message according to an embodiment of the present invention. A description of the method of FIG. 4 will be provided with reference to the apparatus 100 of FIG. 1 for purposes of illustration, but is not limited thereto. It is to be assumed, again for purposes of illustration, that the text message for speech synthesis is that presently input by the user and not a text message that has been created beforehand and stored in a predetermined storage space (not shown) of a terminal. However, it is understood that such stored text messages could be used in other aspects.

First, the user creates a text message for transmission to a receiver (S401).

The user selects voice parameters that are close to his or her actual voice and that reflect his or her emotional state through an input mechanism (such as a keypad), and the voice parameter processor 110 receives the input of voice parameters for the created text message (S402).

“Voice parameters” refer to intervening variables for speech synthesis, and are used to convert a text message into a voice message through speech synthesis in such a manner that the voice message closely resembles the actual voice of the sender and conveys the emotions of the sender. Voice parameters may include at least one of a specific tone quality of the sender, pitch, volume, speed, expression of emotions, and voice gender. A more detailed description with respect to voice parameters was provided in the above description of the apparatus 100 of FIG. 1, and hence, will not be repeated.

Additionally, the voice parameter processor 110 may combine the input voice parameters for storage as a single unit of information which can be used at a later time, but this is not required in all aspects. That is, when the sender creates a text message for a particular situation and desires to transmit a corresponding voice message to a receiver, voice parameters that convey the present emotions of the sender are selected and the voice parameters are stored as information in a predetermined format. Accordingly, if the same or similar situation is encountered in the future, a voice message that conveys the emotions of the sender may be transmitted to the receiver by using the stored voice parameters stored in the predetermined format without having to select each of the voice parameters.

In this case, the predetermined format in which the voice parameters are stored may be that of a “file” format. When such a file is stored, it is preferable that a name be used for the file that allows for the contents of the file to be easily ascertained. However, the types of voice parameters, the manner in which the voice parameters are indicated, and the storage formats for the voice parameters may be varied in a multitude of ways as may be contemplated by those skilled in the art, and these aspects of the voice parameters are not limited to the disclosed embodiments of the present invention. Moreover, such voice parameters could be selected according to contents of the text message, such as when the message includes emoticons indentifying an emotion associated with the message.

It is noted that if the sending terminal and the receiving terminal are present in the same voice database (i.e., both access or are synchronized with the same or a portion of the same voice database), the voice parameter processor 110 extracts indexes of the voice database corresponding to input voice parameters, and stores the indexes as information of a predetermined format, such that the sender is able to use this in the future.

In addition, as explained while describing the apparatus 100 of FIG. 1, at least one of the voice parameters and the indexes of the voice database corresponding to the voice parameters may be included in the data packet. For purposes of illustration, it is assumed that voice parameters are included in the data packet.

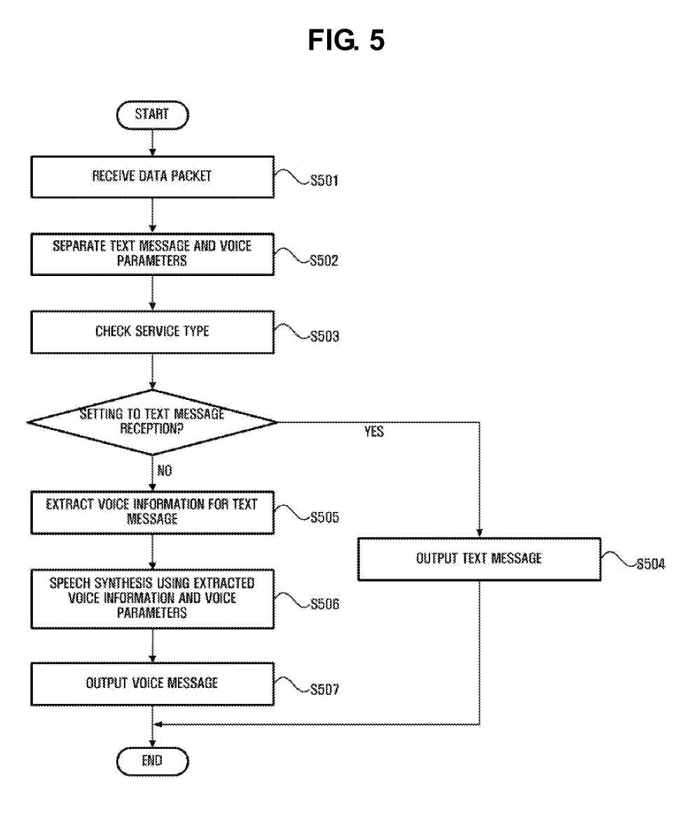

Accordingly, “voice parameters” as used herein while describing the processes of FIG. 4 and FIG. 5 may also be taken to encompass “voice database indexes” in the case where the sending terminal and the receiving terminal exist in the same voice database.

After the voice parameters are received (S402), the packet combining unit 120 stores each of the text message and voice parameters input to the voice parameter processor 110 in the data packet (S403). The transmitter 130 transmits the data packet, which includes the text message and voice parameters, to the receiving terminal (S404).

It is to be noted that the data packet transmitted by the transmitter 130 is transmitted to the receiving terminal through a conventional mobile communications system, such as a base station, an exchanger, a home location register, message service center, etc. However, it is understood that the message can be sent through other mechanisms.

FIG. 5 is a flowchart of a method for speech synthesis of a text message according to another embodiment of the present invention. For purposes of illustration, a description of the method of FIG. 5 will be provided with reference to the apparatus 100 of FIG. 1 and the apparatus 300 of FIG. 3. The receiver 310 of the apparatus 300 shown in FIG. 3 receives the data packet transmitted by the transmitter 130 of the apparatus 100 shown in FIG. 1 (S501). The voice information extractor 320 separates the text message and the voice parameters in the data packet received by the receiver 310 (S502). The controller 360 checks the service type set in the service type setting unit 340 (S503).

If the result of the check is a setting to “text message reception,” the controller 360 outputs the text message separated in the data packet through the output unit 350 such as a screen (S504). However, if the result of the check in S503 is a setting to “voice message reception,” the voice information extractor 320 extracts the voice information for the separated text message (S505). While not specifically limited thereto, the voice information may include at least one of syntax structure and cadence information for the text message. A detailed explanation in this respect was provided in the description of the apparatus of FIG. 3, and hence, will be omitted.

The service type setting unit 340 may also be set so that both the text message and the voice message are output, in which case operation S503 is not needed.

After the voice information is extracted (S505), the speech synthesizer 330 performs speech synthesis using the voice information extracted by the voice information extractor 320 and the separated voice parameters (S506). Since the speech synthesizer 330 performs speech synthesis using the voice information extracted by the voice information extractor 320 and the voice parameters, separate voice data selection for speech synthesis does not need to be performed at the receiving terminal.

Finally, the synthesized speech is output through the output unit 350 (S507). Examples include a speaker, headphones or a wired and/or wireless connection to such audio devices.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for speech synthesis of a text message, the apparatus comprising:
a voice parameter processor which receives input voice parameters for a text message, the voice parameters being used by a receiving terminal to perform speech synthesis of the text message;
a packet combining unit which stores the text message and the input voice parameters in a data packet; and
a transmitter which transmits the data packet including the text message and the voice parameters to the receiving terminal.

2. The apparatus of claim 1, wherein the voice parameters comprise a specific tone quality of a sender, pitch, volume, speed, expression of emotions, and voice gender, or combinations thereof.

3. The apparatus of claim 1, further comprising a voice database which stores the voice parameters, wherein the voice parameter processor extracts indexes of the voice database corresponding to the input voice parameters.

4. The apparatus of claim 1, wherein the voice parameter processor combines and stores the input voice parameters as information in a predetermined format.

5. The apparatus of claim 3, wherein the voice parameter processor combines and stores the extracted indexes of the voice database as information in a predetermined format.

6. The apparatus of claim 3, wherein the packet combining unit stores the text message and the extracted indexes of the voice database in the data packet.

7. An apparatus for speech synthesis of a text message, the apparatus comprising:
a voice information extractor which extracts voice information and voice parameters for the text message from a received data packet that includes the text message and the voice parameters for the text message;
a speech synthesizer which performs speech synthesis using the extracted voice information and the voice parameters to obtain a voice message corresponding to the text message; and
a service type setting unit which selectively outputs the text message and the voice message, depending on the circumstances of a user.

8. The apparatus of claim 7, further comprising a receiver which receives the data packet that includes the text message and the voice parameters for the text message.

9. The apparatus of claim 7, wherein the voice information comprises syntax structure and/or cadence information for the text message.

10. The apparatus of claim 7, wherein the voice parameters comprise a specific tone quality of a sender, pitch, volume, speed, expression of emotions, voice gender, or combinations thereof.

11. The apparatus of claim 7, further comprising a voice database which stores the voice parameters, wherein, to extract the voice parameters, the voice information extractor extracts indexes of the voice database for the text message from the data packet that includes the text message and the indexes and extracts the voice parameters for the text message according to the extracted indexes.

12. The apparatus of claim 11, wherein the speech synthesizer performs speech synthesis using the extracted voice information and the indexes of the voice database.

13. A method for speech synthesis of a text message, the method comprising:
receiving input of voice parameters for a text message, the voice parameters being used to perform speech synthesis on the text message at a receiving terminal;
storing the text message and the input voice parameters in a data packet; and
transmitting the data packet including the text message and the voice parameters to the receiving terminal.

14. The method of claim 13, wherein the voice parameters comprise specific tone quality of a sender, pitch, volume, speed, expression of emotions, voice gender or combinations thereof.

15. The method of claim 13, wherein the receiving of the input of voice parameters comprises extracting indexes of a voice database corresponding to the input voice parameters, the voice database storing the voice parameters.

16. The method of claim 13, wherein the receiving of the input of voice parameters comprises combining and storing the input voice parameters as information in a predetermined format.

17. The method of claim 15, wherein the receiving of the input of voice parameters comprises combining and storing the extracted indexes of the voice database as information in a predetermined format.

18. The method of claim 15, wherein the storing the text message and the input voice parameters comprises storing the text message and the extracted indexes of the voice database in the data packet.

19. A method for speech synthesis of a text message, the method comprising:
extracting voice information and voice parameters for the text message from a data packet that includes the text message and the voice parameters for the text message;
synthesizing speech using the extracted voice information and the voice parameters to obtain a voice message corresponding to the text message; and
outputting the text message and/or the voice message, depending on a selection by a user.

20. The method of claim 19, further comprising receiving the data packet that includes the text message and the voice parameters for the text message.

21. The method of claim 19, wherein the voice information comprises syntax structure and/or cadence information for the text message.

22. The method of claim 19, wherein the voice parameters comprise a specific tone quality of a sender, pitch, volume, speed, expression of emotions, voice gender or combinations thereof.

23. The method of claim 19, wherein the extracting of the voice information and the voice parameters comprises extracting the voice information and indexes of a voice database for the text message from the data packet that includes the text message and the indexes, and extracting the voice parameters from the voice database according to the extracted indexes.

24. The method of claim 23, wherein the synthesizing of speech comprises synthesizing the speech using the extracted voice information and the indexes of the voice database.

25. The apparatus of claim 1, wherein the transmitter transmits the text message in according to a short message service (SMS) protocol.

26. A mobile phone including the apparatus of claim 1.

27. The apparatus of claim 1, further comprising a voice database which stores one of more of the voice parameters, wherein the voice parameter processor receives one or more of the input voice parameters for the text message using the stored voice parameters stored in the voice database.

28. The apparatus of claim 7, further comprising:
a voice parameter processor which receives input voice parameters for a text message to be sent, the voice parameters being used by a receiving terminal to perform speech synthesis of the text message;
a packet combining unit which stores the text message and the input voice parameters in another data packet to be transmitted; and
a transmitter which transmits the another data packet to the receiving terminal.

29. The apparatus of claim 7, wherein the text message is received according to a short message service (SMS) protocol.

30. A mobile phone including the apparatus of claim 28.

31. A computer readable medium encoded with processing instructions for implementing the method of claim 13 using one or more processors.

32. A computer readable medium encoded with processing instructions for implementing the method of claim 19 using one or more processors.

33. An apparatus for speech synthesis of a text message, the apparatus comprising:
a packet combining unit combines into at least one packet the text message and voice parameters associated with the text message, the voice parameters being used by a receiving terminal to perform speech synthesis of the text message; and
a transmitter which transmits the data packet to the receiving terminal.

34. An apparatus for speech synthesis of a text message, the apparatus comprising:
a voice information extractor which extracts voice parameters for the text message from a received data packet that includes the text message and the voice parameters for the text message, the voice parameters having been specified by a transmitting terminal which transmitted the data packet to the apparatus; and
a speech synthesizer which performs speech synthesis using the extracted voice parameters to obtain a voice message corresponding to the text message.
